(19) United States
(12) Patent Application Publication
(10) Pub. No.: US 2025/0110564 A1
(43) Pub. Date: Apr. 3, 2025

(54) DISPLAY MODULE AND CONTROL METHOD THEREFOR, AND DISPLAY APPARATUS

(71) Applicants: Beijing BOE Display Technology Co., Ltd., Beijing (CN); BOE Technology Group Co., Ltd., Beijing (CN)

(72) Inventors: Wenqian LUO, Beijing (CN); Jingrui REN, Beijing (CN); Xin GAI, Beijing (CN); Yuan JIA, Beijing (CN); Yujia ZHANG, Beijing (CN); Tianyi FENG, Beijing (CN); Weibiao GENG, Beijing (CN); Fanglin LI, Beijing (CN)

(21) Appl. No.: 18/729,183

(22) PCT Filed: May 12, 2023
(86) PCT No.: PCT/CN2023/093973

§ 371 Date: Jul. 16, 2024

(30) Foreign Application Priority Data
May 24, 2022 (CN) 202210573088.0

(51) Int. Cl. G06F 3/01; G09G 3/20

(52) U.S. Cl. CPC G06F 3/017; G09G 3/20; G09G 2310/08

(57) ABSTRACT

Disclosed is a display module comprising a timing controller which comprises an identification unit and a determination unit, wherein the identification unit is configured to receive and identify a control signal sent by the display controller and output a first feedback signal to the display controller when the control signal is identified as a handshake signal, the first feedback signal being used for triggering the display controller to send a handshake parameter; and the determination unit is connected to the display controller, and is configured to receive the handshake parameter sent by the display controller, determine whether the handshake parameter matches a handshake parameter pre-stored in the determination unit, if so, determine that handshake is successful, and output a second feedback signal to the display controller, the second feedback signal being used for triggering the display controller to send a video signal, and if not, determine that handshake fails.

### CROSS-REFERENCE TO RELATED APPLICATIONS

The present application is a U.S. National Phase Entry of International Application No. PCT/CN2023/093973 having an international filing date of May 12, 2023, which claims priority to Chinese Patent Application No. 202210573088.0, filed to the CNIPA on May 24, 2022, contents of the above-identified applications should be construed as being incorporated into the present application by reference.

### TECHNICAL FIELD

The present disclosure relates to, but is not limited to, the field of display technologies. Particularly, the present disclosure relates to a display module, a control method therefor, and a display apparatus.

### BACKGROUND

At present, a display module has no specific setting for an overall drive architecture, which will lead to any display controller with a corresponding resolution (the display controller may be a System On Chip (SOC)) supporting normal display of a screen of the display module and unable to meet a customization demand for the display controller.

That is to say, the current display module may support all display controllers, which cannot meet users' customization demand.

### SUMMARY

The following is a summary of subject matters described in the present disclosure in detail. The summary is not intended to limit the protection scope of claims.

An exemplary embodiment of the present disclosure provides a display module, which includes a timing controller; the timing controller includes an identification unit and a determination unit; wherein the identification unit is connected with a display controller, and is configured to receive a control signal transmitted by the display controller, identify the control signal, and output a first feedback signal to the display controller when the control signal is identified as a handshake signal, wherein the first feedback signal is used for triggering the display controller to transmit a handshake parameter; the determination unit is connected with the display controller, and is configured to receive the handshake parameter transmitted by the display controller, determine whether the handshake parameter matches a handshake parameter pre-stored by the determination unit, determine that handshake succeeds when the handshake parameter matches the pre-stored handshake parameter, and output a second feedback signal to the display controller, wherein the second feedback signal is used for triggering the display controller to transmit a video signal, and determine that handshake fails when the handshake parameter does not match the pre-stored handshake parameter.

In an exemplary implementation mode, the handshake signal is a high-level signal; the identification unit is configured to identify the control signal, and output the first feedback signal to the display controller when the control signal is identified as the high-level signal.

In an exemplary implementation mode, the handshake parameter includes an encryption command and a register address; the determination unit is configured to determine whether the encryption command is consistent with a pre-stored encryption command and whether the register address is consistent with a pre-stored register address, and when both the encryption command and the register address are consistent respectively, determine that handshake succeeds; when any one of the encryption command and the register address is inconsistent, determine that handshake fails.

In an exemplary implementation mode, a source driver, a gate driver, and a display panel are further included; wherein the timing controller further includes a video unit; the video unit is connected with the display controller, and is configured to receive a video signal transmitted by the display controller, output a display signal to the source driver based on the video signal and output a gate control signal to the gate driver; the display panel is configured to display under drive of the source driver and the gate driver.

In an exemplary implementation mode, the source driver includes a Clock-Embedded Differential Signaling (CEDS) interface, and the timing controller is connected with the source driver through the CEDS interface.

In an exemplary implementation mode, the display panel includes a display region and a non-display region, wherein the source driver is configured to output a data signal to the display region; and the gate driver is configured to output a scan signal to the display region.

In an exemplary implementation mode, the source driver includes at least one drive circuit board and at least one source drive module; the gate driver includes a first gate drive circuit and a second gate drive circuit.

In an exemplary implementation mode, the timing controller further includes a control interface, a communication interface, and a video interface; wherein the identification unit is connected with the display controller through the control interface; the determination unit is connected with the display controller through the communication interface; and the video unit is connected with the display controller through the video interface.

In an exemplary implementation mode, the video interface includes a V-by-One (VBO) interface.

In an exemplary implementation mode, the timing controller further includes a storage unit; wherein the storage unit is configured to store the pre-stored encryption command and the pre-stored register address.

In an exemplary implementation mode, the storage unit includes a non-volatile memory, and the non-volatile memory includes a FLASH memory.

An exemplary embodiment of the present disclosure provides a display apparatus, which includes a display controller and any display module described above; the display controller is configured to transmit a control signal to a timing controller of the display module, and transmit a handshake parameter to the timing controller after receiving a first feedback signal; and transmit a video signal to the timing controller for identification after receiving a second feedback signal.

In an exemplary implementation mode, a central processor is further included; the central processor is connected with the display controller; the display controller is configured to receive a handshake parameter transmitted by the central processor, and transmit the received handshake parameter to the timing controller; the display controller is further configured to receive a video signal transmitted by the central processor, and transmit the received video signal to the timing controller.

An exemplary embodiment of the present disclosure provides a control method of a display module, which is applied to any display module described above, and the control method includes: receiving a control signal transmitted by a display controller, identifying the control signal, and outputting a first feedback signal to the display controller when the control signal is identified as a handshake signal, wherein the first feedback signal is used for triggering the display controller to transmit a handshake parameter; receiving the handshake parameter transmitted by the display controller, determining whether the handshake parameter matches a pre-stored handshake parameter, determining that handshake succeeds when the handshake parameter matches the pre-stored handshake parameter, and outputting a second feedback signal to the display controller, wherein the second feedback signal is used for triggering the display controller to transmit a video signal, and determining that handshake fails when the handshake parameter does not match the pre-stored handshake parameter.

In an exemplary implementation mode, the identifying the control signal and outputting the first feedback signal to the display controller when the control signal is identified as the handshake signal, includes: identifying the control signal, and outputting the first feedback signal to the display controller when the control signal is identified as a high-level signal.

In an exemplary implementation mode, the handshake parameter includes an encryption command and a register address, the determining whether the handshake parameter matches the pre-stored handshake parameter, determining that handshake succeeds when the handshake parameter matches the pre-stored handshake parameter, and outputting the second feedback signal to the display controller, includes: determining whether the encryption command is consistent with a pre-stored encryption command, and determining whether the register address is consistent with a pre-stored register address, determining handshake succeeds when both the encryption command and the register address are consistent respectively, and outputting the second feedback signal to the display controller.

In an exemplary implementation mode, the determining whether the encryption command is consistent with the pre-stored encryption command, and determining whether the register address is consistent with the pre-stored register address, determining handshake succeeds when both the encryption command and the register address are consistent respectively, and outputting the second feedback signal to the display controller, includes: receiving the register address transmitted by the display controller; determining whether the register address is consistent with the pre-stored register address, and when consistent, transmitting an answering signal to the display controller; receiving the encryption command transmitted by the display controller, and storing the encryption command in a register corresponding to the register address; determining whether the encryption command is consistent with the pre-stored encryption command, and when consistent, determining handshake succeeds, and transmitting an answering signal to the display controller.

In an exemplary implementation mode, the control method of the display module further includes: receiving the video signal transmitted by the display controller, outputting a display signal to a source driver based on the video signal, and outputting a gate control signal to a gate driver, to enable a display panel to display a picture under drive of the source driver and the gate driver.

In an exemplary implementation mode, the handshake parameter includes an encryption command and a register address, the determining whether the handshake parameter matches the pre-stored handshake parameter, and determining that handshake fails when the handshake parameter does not match the pre-stored handshake parameter, includes: determining whether the encryption command is consistent with a pre-stored encryption command and determining whether the register address is consistent with a pre-stored register address, determining that handshake fails when any one of the encryption command and the register address is inconsistent, and outputting a third feedback signal to the display controller or no feedback signal is output to the display controller, to enable a display panel to display a preset picture.

An exemplary embodiment of the present disclosure also provides a non-transitory computer readable storage medium, which stores computer-executable instructions for executing any control method of the display module described above.

Other aspects may be comprehended after drawings and detailed description are read and understood.

### BRIEF DESCRIPTION OF DRAWINGS

FIG. 1 is a schematic frame diagram of a display apparatus according to an exemplary embodiment of the present disclosure.

FIG. 2 is a schematic frame diagram of another display apparatus according to an exemplary embodiment of the present disclosure.

FIG. 3 is a schematic frame diagram of yet another display apparatus according to an exemplary embodiment of the present disclosure.

FIG. 4 is a flowchart of a control method of a display module according to an exemplary embodiment of the present disclosure.

FIG. 5 is a flowchart of another control method of a display module according to an exemplary embodiment of the present disclosure.

FIG. 6 is a flowchart of yet another control method of a display module according to an exemplary embodiment of the present disclosure.

### DETAILED DESCRIPTION

Specific implementation modes of the present disclosure will be described further in detail below in combination with the accompanying drawings and embodiments. Following embodiments are used for illustrating the present disclosure, but are not intended to limit the scope of the present disclosure. The embodiments and features in the embodiments of the present disclosure may be randomly combined with each other if there is no conflict.

The present disclosure will be described below in detail. Examples of the embodiments of the present disclosure are illustrated in the drawings throughout which same or similar reference signs represent same or similar components or components with same or similar functions. In addition, detailed description of a known technology is omitted if it is unnecessary to illustrated features of the present disclosure.

It may be understood by those skilled in the art that unless otherwise defined, all terms (including technical terms and scientific terms) used in the present disclosure have same meanings as commonly understood by those of ordinary skills in the art that to which the present disclosure pertains. Terms, for example, defined in a general dictionary, should be understood as having same meanings as those in the context of the prior art, and may not be explained as idealized or too formal meanings, unless specifically defined as herein.

It may be understood by those skilled in the art that unless specifically stated, singular forms “one”, “a/an”, “said”, and “the” used herein may also include plural forms. Wording “include” used in the specification of the present disclosure refers to existence of a feature, an integer, an act, an operation, an element, and/or a component, but does not exclude existence or addition of one or more other features, integers, acts, operations, elements, components, and/or groups thereof. When stating that an element is “connected” or “coupled” to another element, such element may be directly connected or coupled to another element, or there may be an intermediate element. In addition, “connected” or “coupled” used herein may include a wireless connection or wireless coupling. Wording “and/or” used herein includes all or any one unit and all combinations of one or more listed items that are associated.

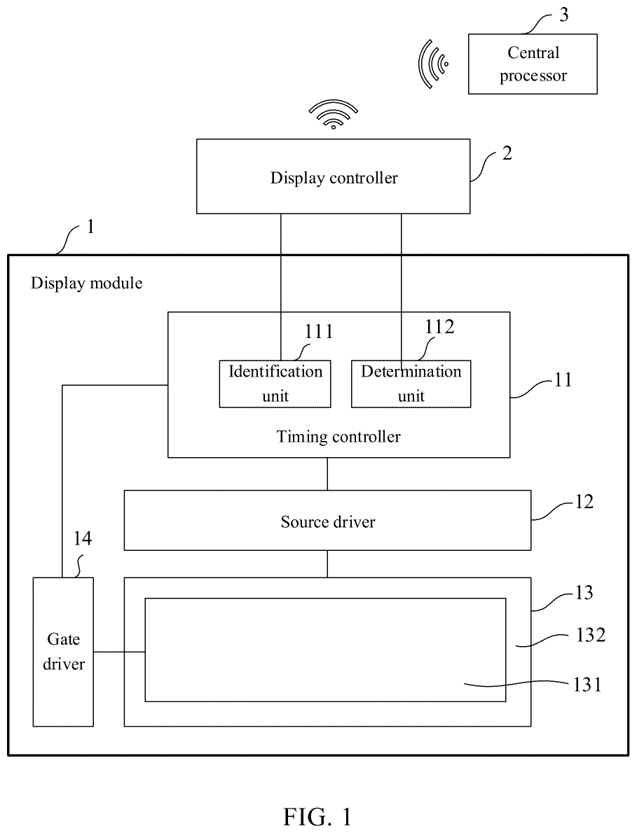

An exemplary embodiment of the present disclosure provides a display module 1, as shown in FIG. 1, the display module 1 includes a timing controller 11, and the timing controller 11 includes an identification unit 111 and a determination unit 112.

In an exemplary implementation mode, the identification unit 111 is connected with a display controller 2, and is configured to receive a control signal transmitted by the display controller 2, identify the control signal, and output a first feedback signal to the display controller 2 when the control signal is identified as a handshake signal, wherein the first feedback signal is used for triggering the display controller 2 to transmit a handshake parameter.

The determination unit 112 is connected with the display controller 2, and is configured to receive the handshake parameter transmitted by the display controller 2, determine whether the handshake parameter matches a handshake parameter pre-stored by the determination unit 112, determine that handshake succeeds when they match, and output a second feedback signal to the display controller 2, wherein the second feedback signal is used for triggering the display controller 2 to transmit a video signal, and determine that handshake fails when they do not match.

Whether the handshake parameter transmitted by the display controller 2 matches the handshake parameter pre-stored by the determination unit 112 may include whether the handshake parameter is in one-to-one correspondence, complementary, or consistent with the pre-stored handshake parameter, as long as the handshake parameter matches the pre-stored handshake parameter, which is not limited in the exemplary embodiment of the present disclosure.

In an exemplary implementation mode, the display controller 2 includes a System On Chip (SOC).

The display controller 2 may be integrated with the display module 1, or may be disposed separately, which is not limited in the exemplary embodiment of the present disclosure.

The display module 1 according to the exemplary embodiment of the present disclosure includes the timing controller 11 in which the identification unit 111 and the determination unit 112 are disposed. It is identified that whether the handshake signal is received through the identification unit 111, and when it is identified the handshake signal is received, the first feedback signal which is used for triggering the display controller to transmit the handshake parameter is output to the display controller. The determination unit 112 receives the handshake parameter transmitted by the display controller, and it is determined that handshake succeeds when the handshake parameter matches the handshake parameter pre-stored by the determination unit 112. After the handshake succeeds, the determination unit 112 outputs the second feedback signal to the display controller, the second feedback signal is used for triggering the display controller to transmit a video signal. The display controller 2 may communicate with a central processor 3, and the display module 1 can display normally after handshake of the timing controller 11 with the central processor 3 succeeds. That is to say, the display module according to the embodiment of the present application does not support all display controllers, and a display controller which is capable of achieving the above-mentioned interaction may perform normal display communication with a display module, thereby meeting customers' customization demand.

In some exemplary embodiments, the handshake signal is a high-level signal. The identification unit 111 is configured to identify the control signal, and output the first feedback signal to the display controller 2 when the control signal is identified as a high-level signal.

In some exemplary embodiments, the handshake parameter includes an encryption command and a register address. The determination unit 112 is configured to determine whether the encryption command is consistent with a pre-stored encryption command and determine whether the register address is consistent with a pre-stored register address, and when both are consistent, it is determined that handshake succeeds; when any one of the encryption command and the register address is inconsistent, it is determined that handshake fails.

In an exemplary implementation mode, the determination unit 112 outputs a second feedback signal to the display controller 2 after determining that handshake succeeds, and does not output a signal or outputs a third feedback signal to the display controller 2 after determining that handshake fails. The display controller 2 determines not to transmit a video signal to the timing controller 11 when no signal is received or the third feedback signal is received.

In an exemplary implementation mode, the pre-stored encryption command may be 0x01, for example. Of course, it may be another encryption command, which is not limited in the exemplary embodiment of the present disclosure.

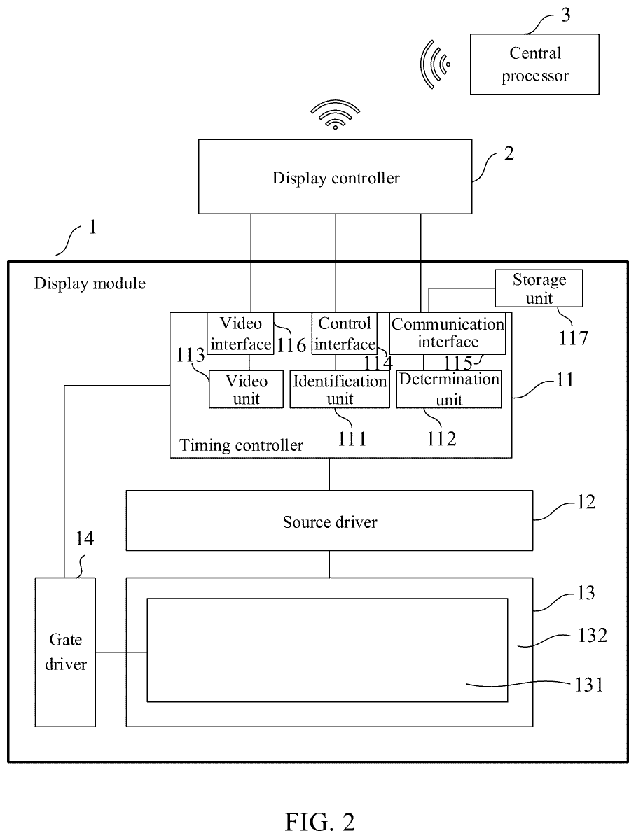

In some exemplary embodiments, as shown in FIG. 1 or FIG. 2, the display module 1 further includes a source driver 12, a gate driver 14, and a display panel 13, and the timing controller 11 includes a video unit 113.

The video unit 113 is connected with the display controller 2 and is configured to receive a video signal transmitted by the display controller 2, output a display signal to the source driver 12 based on the video signal, and output a gate control signal to the gate driver 14.

The display panel 13 is configured to display under drive of the source driver 12 and the gate driver 14.

In an exemplary implementation mode, the source driver 12 includes a Clock-Embedded Differential Signaling (CEDS) interface, the timing controller 11 is electrically connected with the source driver 12 through the CEDS interface. The embodiment of the present disclosure may be used for a large-sized high-resolution display panel by employing the CEDS interface.

In an exemplary embodiment, the video unit 113 of the timing controller 11 outputs a display signal to the source driver 12 based on the received video signal, and outputs a gate control signal to the gate driver 14.

In some embodiments, as shown in FIG. 2, the timing controller 11 further includes a control interface 114, a communication interface 115, and a video interface 116.

The identification unit 111 is connected with the display controller 2 through the control interface 114, the determination unit 112 is connected with the display controller 2 through the communication interface 115, and the video unit 113 is connected with the display controller 2 through the video interface 116.

In an exemplary implementation mode, the communication interface 115 includes an Inter-Integrated Circuit (I2C) interface.

In an exemplary implementation mode, the video interface 116 includes a VBO interface. VBO is also known as Vedio-by-One, which has a fast transmission speed and may greatly reduce wirings on a Printed Circuit Board (PCB). The VBO is a signal protocol between the central processor 3, the display controller 2, and the timing controller 11. The exemplary embodiment of the present disclosure may be used for a large-sized high-resolution display panel by employing the VBO interface.

In an exemplary implementation mode, the timing controller 11 includes a timing control chip, the timing control chip includes a control pin which is electrically connected with the control interface 114, and when the control interface 114 receives a high-level signal transmitted by the display controller 2, a voltage of the control interface 114 may be pulled high, and then a voltage of the control pin may be pulled high. When the voltage of the control pin is pulled high, the identification unit 111 identifies a control signal as a handshake signal, and outputs a first feedback signal to the display controller 2. For example, the voltage of the control interface 114 may be pulled high to 3.3 V (volt).

In some exemplary embodiments, as shown in FIG. 2, the timing controller 11 further includes a storage unit 117. The storage unit 117 is configured to store a pre-stored encryption command, and to store a pre-stored register address.

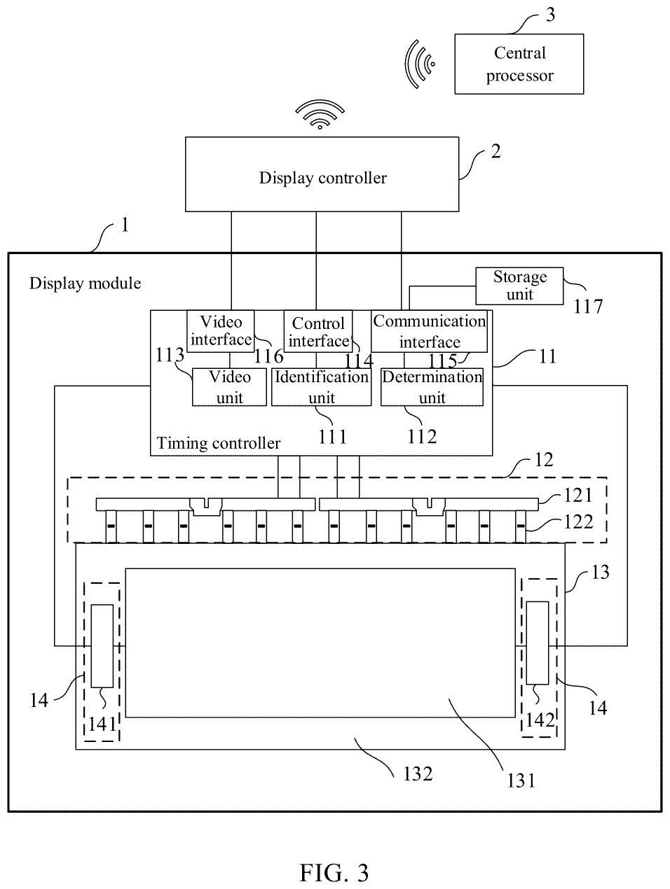

In an exemplary implementation mode, the storage unit 117 may be external or built-in, which is not limited in the exemplary embodiment of the present disclosure. As shown in FIGS. 2 and 3, the storage unit 117 is an external storage unit which is electrically connected with the determination unit 112 through the communication interface 115.

In an exemplary implementation mode, the storage unit 117 includes a non-volatile memory, and the non-volatile memory includes a FLASH memory.

In an exemplary implementation mode, the storage unit 117 is further configured to store an encryption command and a register address transmitted by the display controller 2. In addition, the storage unit 117 may also be configured to store program codes in the timing controller 11.

In an exemplary implementation mode, as shown in FIGS. 1 to 3, the display panel 13 further includes a display region 131 and a non-display region 132. The source driver 12 is configured to output a data signal to a plurality of pixel units of the display region 131 of the display panel 13. The gate driver 14 is configured to output a scan signal to a plurality of pixel units of the display region 131 of the display panel 12.

In an exemplary implementation mode, the source driver 12 includes at least one drive circuit board 121 and at least one source drive module 122.

As shown in FIG. 2, in an exemplary embodiment, the source driver 12 includes 4 drive circuit boards 121 and 12 source drive modules 122. Each of the drive circuit boards 121 is electrically connected with three of the source drive modules 122, two of the drive circuit boards 121 on a left side are connected through one connector, and two of the drive circuit boards 121 on a right side are connected through another connector. Among them, quantities of the drive circuit boards 121 and the source drive modules 122 are not limited in the exemplary embodiment of the present disclosure.

As shown in FIG. 3, in an exemplary embodiment, the gate driver 14 includes a first gate drive circuit 141 and a second gate drive circuit 142, both of the first gate drive circuit 141 and the second gate drive circuit 142 are located in the non-display region 132 of the display panel 13 and located on both sides of the display region 131. In an exemplary implementation mode, the gate driver 14 may also be located in the non-display region 132 and located on one side of the display region 131. For example, the gate driver 14 may be located on a left or right side of the display region 131, which is not specifically limited in the exemplary embodiment of the present disclosure. In an exemplary implementation mode, both of the first gate drive circuit 141 and the second gate drive circuit 142 are Gate on Array (GOA) circuits.

In order to meet customers' demand for customizing a screen and use a customized system, before a screen of the display module 1 is normally displayed, the display controller 2 needs to write a specific value for the timing controller 11 through an Inter-Integrated Circuit (IIC) protocol before the screen can be normally displayed. If no specific value is written, the screen is always in a picture of black insertion, so that only a display controller 2 of a customer can be used for a corresponding screen, and the screen is always in the picture of black insertion when using other display controllers 2.

How the display module 1 in the embodiment of the present disclosure achieves the above functions will be described in detail below with reference to FIG. 1.

The display controller 2 may be wired or wirelessly connected with the central processor 3 (also referred to as a front-end processor).

First, a display apparatus is normally powered on. That is, power is supplied to the central processor 3, the display controller 2, and the display module 1 according to a corresponding time sequence. At this time, the central processor 3 does not output a signal to the display module 1, and the display module 1 displays a preset picture. Among them, the preset picture may be a set default picture, a black insertion picture, a black screen, or other pictures.

Then, the display controller 2 transmits a control signal to pull up a voltage of the control interface 114 of the timing controller 11 in the display module 1. The identification unit 111 of the timing controller 11 identifies that the central processor 3 is about to give a handshake signal at this time, and outputs a first feedback signal to the display controller 2.

Then, the central processor 3 receives the first feedback signal through the display controller 2. Based on the first feedback signal, the central processor 3 transmits an encryption command and a register address that are set in advance to the timing controller 11 through the display controller 2. The determination unit 112 of the timing controller 11 receives the encryption command and the register address transmitted by the display controller 2, and determines whether the encryption command and the register address transmitted by the display controller 2 are consistent with an encryption command and a register address which are pre-stored by the timing controller 11, when both are consistent, determines that handshake succeeds, and outputs a second feedback signal to the display controller 2; when any one of the encryption command and the register address is inconsistent, it is determined that handshake fails.

Then, the central processor 3 receives the second feedback signal through the display controller 2, and the central processor 3 transmits a video signal to the display controller 2 based on the second feedback signal, the video signal is transmitted to the timing controller 11 through the display controller 2. The timing controller 11 outputs a display signal to the source driver 12, and outputs a gate control signal to the gate driver 14, and the display panel 13 displays a normal picture under drive of the source driver 12 and the gate driver 14.

The control interface 111 of the timing controller 11 has no voltage pull-up process, and the encryption command and register address transmitted by the display controller 2 are inconsistent with one or both of the encryption command and the register address pre-stored by the timing controller 11; or, the control interface 111 of the timing controller 11 has no voltage pull-up process, and the encryption command and register address transmitted by the display controller 2 are inconsistent with one or both of the encryption command and the register address pre-stored by the timing controller 11, then here is no handshake between the display controller 2 and the timing controller 11 or handshake fails, and the display module 1 displays a preset picture. Among them, the preset picture may be a set default picture, a black insertion picture, a black screen, or other pictures.

The display module according to the embodiment of the present application does not support all display controllers, and a display controller which is capable of achieving the above-mentioned interaction can perform normal display communication with the display module, thereby meeting users' customization demand.

An exemplary embodiment of the present disclosure provides a display apparatus, as shown in FIGS. 1 and 2, the display apparatus includes a display controller 2 and a display module 1 according to any of the above-mentioned exemplary embodiments.

The display controller 2 is configured to transmit a control signal to the timing controller 11, transmit a handshake parameter to the timing controller 11 after receiving a first feedback signal, and transmit a video signal to the timing controller 11 after receiving a second feedback signal.

The timing controller 11 is configured to receive the control signal, identify the control signal, and output a first feedback signal to the display controller 2 when identifying the control signal as a handshake signal, receive the handshake parameter, determine whether the handshake parameter matches a handshake parameter pre-stored by a determination unit 112, determine that handshake succeeds if they match, and output a second feedback signal to the display controller 2; and determine that the handshake fails if they do not match.

In some exemplary embodiments, as shown in FIGS. 1 and 2, the display apparatus further includes a central processor 3 connected with the display controller 2. The central processor 3 may be wired or wirelessly connected with the display controller 2. A wireless connection may be a communication connection, etc.

The display controller 2 is configured to receive a handshake parameter transmitted by the central processor 3, and transmit the received handshake parameter to the timing controller 11.

And the display controller 2 is configured to receive a video signal transmitted by the central processor 3, and transmit the received video signal to the timing controller 11.

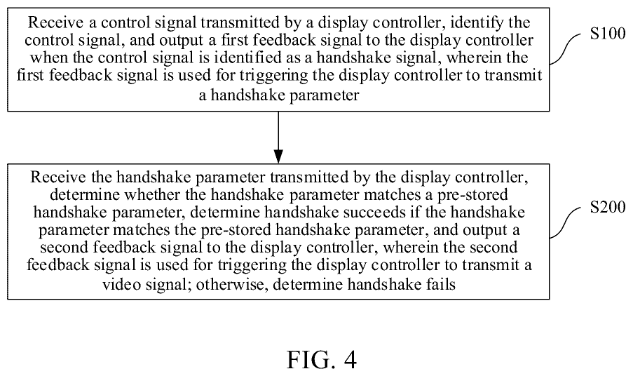

An exemplary embodiment of the present disclosure provides a control method of a display module 1 according to any one of the above-mentioned embodiments. As shown in FIG. 4, the control method for the display module 1 includes acts S100 and S200.

In the act S100, a control signal transmitted by a display controller is received, the control signal is identified, and a first feedback signal is output to the display controller when the control signal is identified as a handshake signal, wherein the first feedback signal is used for triggering the display controller to transmit a handshake parameter.

In the act S200, the handshake parameter transmitted by the display controller is received, it is determined whether the handshake parameter matches a pre-stored handshake parameter, if they match, it is determined that handshake is successful and a second feedback signal is output to the display controller, wherein the second feedback signal is used for triggering the display controller to transmit a video signal; if they do not match, it is determined that handshake fails.

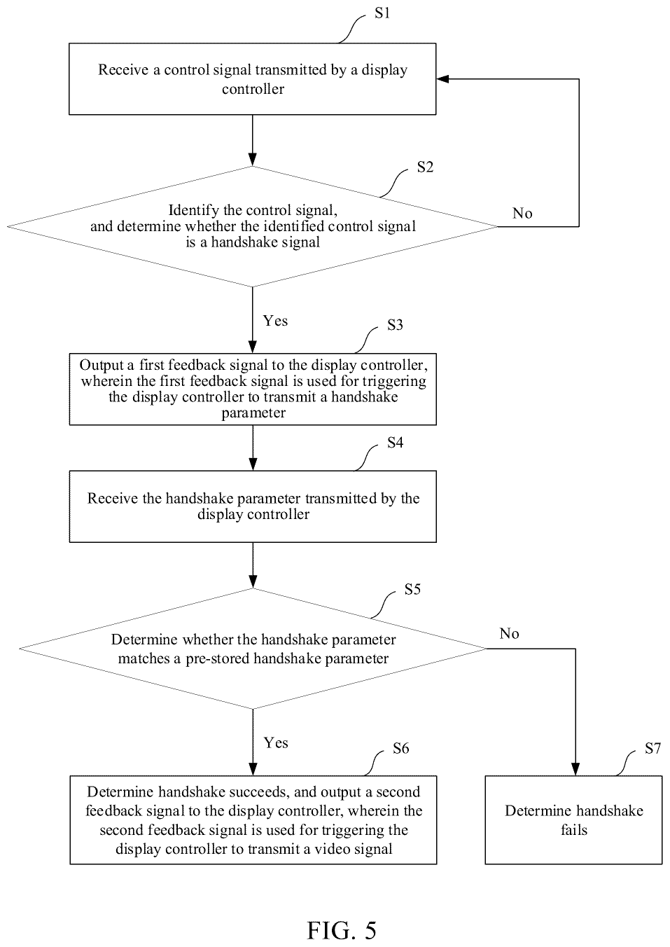

A flowchart of a control method of a display module in an exemplary embodiment of the present disclosure is shown in FIG. 5. The control method of the display module includes acts S1 to S7.

In the act S1, a control signal transmitted by a display controller is received. Then the act S2 is executed.

In an exemplary implementation mode, an identification unit 111 in a timing controller 11 receives the control signal transmitted by the display controller.

In the act S2, the control signal is identified, and whether the identified control signal is a handshake signal is determined; when it is determined that the control signal is a handshake signal, the act S3 is executed. When it is determined that the control signal is not a handshake signal, the act S1 is re-executed.

In an exemplary implementation mode, the identification unit 111 in the timing controller 11 identifies the control signal and determines whether the identified control signal is a handshake signal.

In the act S3, a first feedback signal is output to the display controller, wherein the first feedback signal is used for triggering the display controller to transmit a handshake parameter. Then the act S4 is executed.

In an exemplary implementation mode, the identification unit 111 in the timing controller 11 outputs the first feedback signal to the display controller.

In the act S4, the handshake parameter transmitted by the display controller is received. Then the act S5 is executed.

In an exemplary implementation mode, the determination unit 112 in the timing controller 11 receives the handshake parameter transmitted by the display controller.

In the act S5, whether the handshake parameter matches a pre-stored handshake parameter stored is determined; if they match, the act S6 is executed, and if they do not match, the act S7 is executed.

In an exemplary implementation mode, the determination unit 112 in the timing controller 11 determines whether the handshake parameter matches the pre-stored handshake parameter.

In the act S6, it is determined that handshake is successful, and a second feedback signal is output to the display controller, wherein the second feedback signal is used for triggering the display controller to transmit a video signal.

In the act S7, it is determined that handshake fails.

In an exemplary implementation mode, the determination unit 112 in the timing controller 11 determines whether handshake succeeds. If the handshake succeeds, the determination unit 112 of the timing controller 11 outputs the second feedback signal to the display controller 2.

According to the control method of the display module provided in the exemplary embodiment of the present disclosure, the display module is connected with the display controller, and the display controller is connected with the central processor. Before performing normal display communication, the display module needs to perform handshake with the external central processor. Only after the display module performs handshake with the central processor successfully, the display module can perform normal display communication. According to the control method of the display module provided in the embodiment of the present disclosure, the display module can perform normal display communication only after handshake between the timing controller and the central processor succeeds, which can meet users' customization demand.

In some exemplary embodiments, identifying the control signal, and outputting the first feedback signal to the display controller when the control signal is identified as the handshake signal, includes: identifying the control signal, and outputting the first feedback signal to the display controller when the control signal is identified as a high-level signal.

In some exemplary embodiments, determining whether the handshake parameter matches the pre-stored handshake parameter, if they match, determining handshake is successful and outputting the second feedback signal to the display controller, includes: determining whether an encryption command is consistent with a pre-stored encryption command, and determining whether a register address is consistent with a pre-stored register address, determining handshake is successful when both are consistent, and outputting the second feedback signal to the display controller.

In some exemplary embodiments, determining whether the encryption command is consistent with the pre-stored encryption command, and determining whether the register address is consistent with the pre-stored register address, determining handshake is successful when both are consistent, and outputting the second feedback signal to the display controller, includes: receiving the register address transmitted by the display controller; determining whether the register address is consistent with the pre-stored register address, and when consistent, transmitting an answering signal to the display controller; receiving the encryption command transmitted by the display controller, and storing the encryption command in a register corresponding to the register address; determining whether the encryption command transmitted by the display controller is consistent with the pre-stored encryption command, and when consistent, determining handshake is successful, and transmitting an answering signal to the display controller. The second feedback signal includes two times of answering signals.

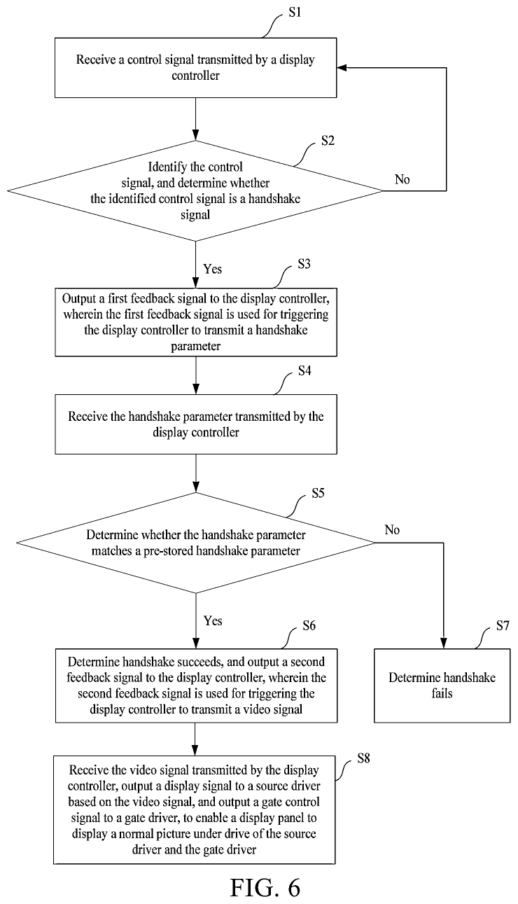

In some exemplary embodiments, as shown in FIG. 6, the control method of the display module further includes an act S8.

In the act S8, the video signal transmitted by the display controller is received, a display signal is output to a source driver based on the video signal, and a gate control signal is output to a gate driver, so that a display panel displays a normal picture under drive of the source driver and the gate driver.

In some exemplary embodiments, determining whether the handshake parameter matches the pre-stored handshake parameter, and determining that the handshake fails if they do not match, includes: determining whether the encryption command is consistent with a pre-stored encryption command and determining whether the register address is consistent with a pre-stored register address, when any one of the two is inconsistent, determining that handshake fails, and outputting a third feedback signal to the display controller or no feedback signal is output to the display controller, so that a display panel displays a preset picture.

In an exemplary implementation mode, the preset picture may be a set default picture, a black insertion picture, a black screen, or other pictures.

By applying the exemplary embodiments of the present disclosure, at least following beneficial effects may be achieved.

According to the display module provided in the exemplary embodiment of the present disclosure, the display module includes the timing controller provided with the identification unit and the determination unit thereon. Whether the handshake signal being received is identified by the identification unit, and when the handshake signal is identified, the first feedback signal which is used for triggering the display controller to transmit the handshake parameter is output to the display controller. The determination unit receives the handshake parameter transmitted by the display controller, and determines that handshake succeeds when the handshake parameter matches the handshake parameter pre-stored by the determination unit. After the handshake succeeds, the second feedback signal is output to the display controller, wherein the second feedback signal is used for triggering the display controller to transmit the video signal. The display controller may be communicatively connected with the central processor, and the display module can perform normal display communication after handshake between the timing controller and the central processor succeeds. That is to say, the display module provided in the embodiment of the present disclosure does not support all display controllers, and a display controller which is capable of achieving the above-mentioned interaction can perform normal display communication with the display module, thereby meeting users' customization demand.

Those of ordinary skills in the art may understand that all or some of acts in the methods disclosed above, systems, functional modules or units in apparatuses may be implemented as software, firmware, hardware, and an appropriate combination thereof. In a hardware implementation mode, division of the function modules/units mentioned in the above description is not always corresponding to division of physical components. For example, a physical component may have multiple functions, or a function or an act may be executed by several physical components in cooperation. Some components or all components may be implemented as software executed by a processor such as a digital signal processor or a microprocessor, or implemented as hardware, or implemented as an integrated circuit such as a specific integrated circuit. Such software may be distributed on a computer readable medium, and the computer readable medium may include a computer storage medium (or a non-transitory medium) and a communication medium (or a transitory medium). As known to those of ordinary skills in the art, a term computer storage medium includes volatile or nonvolatile, and removable or irremovable media implemented in any method or technology for storing information (for example, a computer readable instruction, a data structure, a program module, or other data). The computer storage medium includes, but is not limited to, a Random Access Memory (RAM), a Read Only Memory (ROM), an Electrically Erasable Programmable Read Only Memory (EEPROM), a flash memory or another memory technology, a Compact Disc Read Only Memory (CD-ROM), a Digital Versatile Disk (DVD) or another optical disk storage, a magnetic cartridge, a magnetic tape, magnetic disk storage or another magnetic storage apparatus, or any other medium that may be configured to store desired information and may be accessed by a computer. In addition, it is known to those of ordinary skills in the art that the communication medium usually includes a computer readable instruction, a data structure, a program module, or other data in a modulated data signal of, such as a carrier wave or another transmission mechanism, and may include any information delivery medium.

Those skilled in the art may understand that acts, measures, and solutions in various operations, methods, and processes already discussed in the present disclosure may be alternated, changed, combined, or deleted. Further, other acts, measures, and solutions in various operations, methods, and processes already discussed in the present disclosure may also be alternated, changed, rearranged, divided, combined, or deleted. Further, acts, measures, and solutions in various operations, methods, and processes disclosed in the present disclosure in the prior art may also be alternated, changed, rearranged, divided, combined, or deleted.

In the description of the present disclosure, it needs to be understood that, an orientation or position relationship indicated by terms “center”, “upper”, “lower”, “front”, “rear”, “left”, “right”, “vertical”, “horizontal”, “top”, “bottom”, “inside”, “outside”, or the like is based on an orientation or position relationship shown in the drawings, and is only for ease of description of the present disclosure and simplification of the description, rather than indicating or implying that a referred apparatus or element must have a specific orientation or be constructed and operated in a specific orientation, and therefore may not be understood as a limitation on the present disclosure.

Terms “first” and “second” are only used for description and cannot be construed as indicating or implying relative importance or implicitly indicating a quantity of indicated technical features. Therefore, features defined by “first” and “second” may explicitly or implicitly include one or more such features. In the description of the present disclosure, “multiple” means two or more than two, unless otherwise specified.

In the description of the present disclosure, it should be noted that, unless otherwise specified and defined, terms “mount”, “couple”, and “connect” should be understood in a broad sense. For example, it may be a fixed connection, a detachable connection, or an integrated connection; and it may be a direct connection, an indirect connection through an intermediate medium, or internal communication inside two elements. Those of ordinary skills in the art may understand specific meanings of the above terms in the present disclosure according to specific situations.

Specific features, structures, materials, or characteristics in the description of the specification may be combined in a proper way in any one or more embodiments or examples.

It should be understood that although various acts in flowcharts of the drawings are shown in sequence as indicated by arrows, these acts are not necessarily executed sequentially in sequence as indicated by the arrows. Unless explicitly stated herein, execution of these acts is not strictly limited in order, and may be executed in other orders. Furthermore, at least a part of the acts in the flowcharts of the drawings may include a plurality of sub-acts or stages, which may not necessarily be completed at a same time, but may be executed at different times, and an execution order may not necessarily be carried out sequentially, but may be executed by turns or alternately with other acts or at least a part of sub-acts or stages of other acts.

The above is only part of implementation modes of the present disclosure, and it should be noted that for those of ordinary skills in the art, without departing from principles of the present disclosure, several improvements and embellishments may be made, and these improvements and embellishments should also be regarded as the protection scope of the present disclosure.

1. A display module, comprising: a timing controller; wherein
the timing controller comprises an identification unit and a determination unit;
the identification unit is connected with a display controller, and is configured to receive a control signal transmitted by the display controller, identify the control signal, and output a first feedback signal to the display controller when the control signal is identified as a handshake signal, wherein the first feedback signal is used for triggering the display controller to transmit a handshake parameter;
the determination unit is connected with the display controller, and is configured to receive the handshake parameter transmitted by the display controller, determine whether the handshake parameter matches a handshake parameter pre-stored by the determination unit, determine that handshake succeeds when the handshake parameter matches the pre-stored handshake parameter, and output a second feedback signal to the display controller, wherein the second feedback signal is used for triggering the display controller to transmit a video signal; and determine that handshake fails when the handshake parameter does not match the pre-stored handshake parameter.

2. The display module according to claim 1, wherein the handshake signal is a high-level signal;
the identification unit is configured to identify the control signal, and output the first feedback signal to the display controller when the control signal is identified as the high-level signal.

3. The display module according to claim 1, wherein the handshake parameter comprises an encryption command and a register address;
the determination unit is configured to determine whether the encryption command is consistent with a pre-stored encryption command and whether the register address is consistent with a pre-stored register address, and when both the encryption command and the register address are consistent respectively, determine that handshake succeeds; when any one of the encryption command and the register address is inconsistent, determine that handshake fails.

4. The display module according to claim 1, further comprising: a source driver, a gate driver, and a display panel;
wherein the timing controller further comprises a video unit;
the video unit is connected with the display controller, and is configured to receive a video signal transmitted by the display controller, output a display signal to the source driver based on the video signal and output a gate control signal to the gate driver;
the display panel is configured to display under drive of the source driver and the gate driver.

5. The display module according to claim 4, wherein the source driver comprises a Clock-Embedded Differential Signaling (CEDS) interface and the timing controller is connected with the source driver through the CEDS interface.

6. The display module according to claim 4, wherein the display panel comprises a display region and a non-display region,
wherein the source driver is configured to output a data signal to the display region; and
the gate driver is configured to output a scan signal to the display region.

7. The display module according to claim 6, wherein the source driver comprises at least one drive circuit board and at least one source drive module; and
the gate driver comprises a first gate drive circuit and a second gate drive circuit.

8. The display module according to claim 4, wherein the timing controller further comprises a control interface, a communication interface, and a video interface;
wherein the identification unit is connected with the display controller through the control interface;
the determination unit is connected with the display controller through the communication interface; and
the video unit is connected with the display controller through the video interface.

9. The display module according to claim 8, wherein the video interface comprises a V-by-One (VBO) interface.

10. The display module according to claim 3, wherein the timing controller further comprises a storage unit;
wherein the storage unit is configured to store the pre-stored encryption command and the pre-stored register address.

11. The display module according to claim 10, wherein the storage unit comprises a non-volatile memory, and the non-volatile memory comprises a FLASH memory.

12. A display apparatus comprising: a display controller and a display module according to claim 1;
the display controller is configured to transmit a control signal to a timing controller of the display module, and transmit a handshake parameter to the timing controller after receiving a first feedback signal; and transmit a video signal to the timing controller for identification after receiving a second feedback signal.

13. The display apparatus according to claim 12, further comprising: a central processor, the central processor is connected with the display controller;
the display controller is configured to receive a handshake parameter transmitted by the central processor, and transmit the received handshake parameter to the timing controller;
the display controller is further configured to receive a video signal transmitted by the central processor, and transmit the received video signal to the timing controller.

14. A control method of a display module, applied to a display module according to claim 1, wherein the control method comprises:
receiving a control signal transmitted by a display controller, identifying the control signal, and outputting a first feedback signal to the display controller when the control signal is identified as a handshake signal, wherein the first feedback signal is used for triggering the display controller to transmit a handshake parameter;
receiving the handshake parameter transmitted by the display controller, determining whether the handshake parameter matches a pre-stored handshake parameter, determining that handshake succeeds when the handshake parameter matches the pre-stored handshake parameter, and outputting a second feedback signal to the display controller, wherein the second feedback signal is used for triggering the display controller to transmit a video signal; and determining that handshake fails when the handshake parameter does not match the pre-stored handshake parameter.

15. The control method of the display module according to claim 14, wherein the identifying the control signal and outputting the first feedback signal to the display controller when the control signal is identified as the handshake signal, comprises:
identifying the control signal, and outputting the first feedback signal to the display controller when the control signal is identified as a high-level signal.

16. The control method of the display module according to claim 14, wherein the handshake parameter comprises an encryption command and a register address, the determining whether the handshake parameter matches the pre-stored handshake parameter, determining that handshake succeeds when the handshake parameter matches the pre-stored handshake parameter, and outputting the second feedback signal to the display controller, comprises:
determining whether the encryption command is consistent with a pre-stored encryption command, and determining whether the register address is consistent with a pre-stored register address, determining handshake succeeds when both the encryption command and the register address are consistent respectively, and outputting the second feedback signal to the display controller.

17. The control method of the display module according to claim 16, wherein the determining whether the encryption command is consistent with the pre-stored encryption command, and determining whether the register address is consistent with the pre-stored register address, determining handshake succeeds when both the encryption command and the register address are consistent respectively, and outputting the second feedback signal to the display controller, comprises:
receiving the register address transmitted by the display controller;
determining whether the register address is consistent with the pre-stored register address, and when consistent, transmitting an answering signal to the display controller;
receiving the encryption command transmitted by the display controller, and storing the encryption command in a register corresponding to the register address;
determining whether the encryption command transmitted by the display controller is consistent with the pre-stored encryption command, and when consistent, determining handshake succeeds, and transmitting an answering signal to the display controller.

18. The control method of the display module according to claim 14, further comprising:
receiving the video signal transmitted by the display controller, outputting a display signal to a source driver based on the video signal, and outputting a gate control signal to a gate driver, to enable a display panel to display a picture under drive of the source driver and the gate driver.

19. The control method of the display module according to claim 14, wherein the handshake parameter comprises an encryption command and a register address, the determining whether the handshake parameter matches the pre-stored handshake parameter, and determining that handshake fails when the handshake parameter does not match the pre-stored handshake parameter, comprises:
determining whether the encryption command is consistent with a pre-stored encryption command and determining whether the register address is consistent with a pre-stored register address, determining that handshake fails when any one of the encryption command and the register address is inconsistent, and outputting a third feedback signal to the display controller or no feedback signal is output to the display controller, to enable a display panel to display a preset picture.

20. A non-transitory computer readable storage medium, storing computer-executable instructions for executing a control method of a display module according to claim 14.
